(19) United States
(12) Patent Application Publication
(10) Pub. No.: US 2013/0111228 A1
(43) Pub. Date: May 2, 2013

(54) INFORMATION PROCESSING APPARATUS, METHOD, AND SYSTEM, AND COMPUTER READABLE MEDIUM

(71) Applicant: Kohji HASHIMOTO, Kanagawa (JP)

(72) Inventor: Kohji HASHIMOTO, Kanagawa (JP)

(73) Assignee: FUJI XEROX CO., LTD., Tokyo (JP)

(21) Appl. No.: 13/469,167

(22) Filed: May 11, 2012

(30) Foreign Application Priority Data
Nov. 2, 2011 (JP) 2011-240948

(51) Int. Cl. G06F 1/26

(52) U.S. Cl. 713/300

(57) ABSTRACT

An information processing apparatus includes the following elements. A first reception unit receives information concerning power consumption of a target device and time information. A second reception unit receives information concerning an operation state of the target device and time information. A calculator calculates a value of power consumption of the target device in the operation state, on the basis of the time information received by the first reception unit and the time information received by the second reception unit. An output unit outputs the value of power consumption of the target device calculated by the calculator.

### CROSS-REFERENCE TO RELATED APPLICATIONS

This application is based on and claims priority under 35 USC 119 from Japanese Patent Application No. 2011-240948 filed Nov. 2, 2011.

### BACKGROUND

### (i) Technical Field

The present invention relates to an information processing apparatus, method, and system, and a computer readable medium.

### SUMMARY

According to an aspect of the invention, there is provided an information processing apparatus including: a first reception unit that receives information concerning power consumption of a target device and time information; a second reception unit that receives information concerning an operation state of the target device and time information; a calculator that calculates a value of power consumption of the target device in the operation state, on the basis of the time information received by the first reception unit and the time information received by the second reception unit; and an output unit that outputs the value of power consumption of the target device calculated by the calculator.

### BRIEF DESCRIPTION OF THE DRAWINGS

An exemplary embodiment of the present invention will be described in detail based on the following figures, wherein:

FIG. 1 is a block diagram illustrating an example of the configuration of conceptual modules in an exemplary embodiment;

FIG. 2 is a block diagram illustrating modules forming a configuration of a system in an exemplary embodiment;

FIG. 3 is a flowchart illustrating an example of processing performed in an exemplary embodiment;

FIG. 4 illustrates an example of the data structure of a power information table;

FIG. 5 illustrates an example of the data structure of an operation state table;

FIG. 6 illustrates an example of the data structure of a device-operation-state/power-consumption table;

FIG. 7 illustrates an example of the data structure of a device-operation-state/power-consumption table;

FIG. 8 is a block diagram illustrating an example of the configuration of a system of an exemplary embodiment;

FIG. 9 is a flowchart illustrating an example of processing performed in an exemplary embodiment;

FIG. 10 is a flowchart illustrating an example of processing performed in an exemplary embodiment;

FIG. 11 illustrates an example of the data structure of a device/device-type table;

FIG. 12 illustrates an example of the data structure of a device-type-operation-state/power-consumption table;

FIG. 13 illustrates an example of the data structure of a device-type-operation-state/power-consumption table; and

FIG. 14 is a block diagram illustrating an example of the hardware configuration of a computer implementing an exemplary embodiment.

### DETAILED DESCRIPTION

An exemplary embodiment of the present invention will be described below with reference to the accompanying drawings.

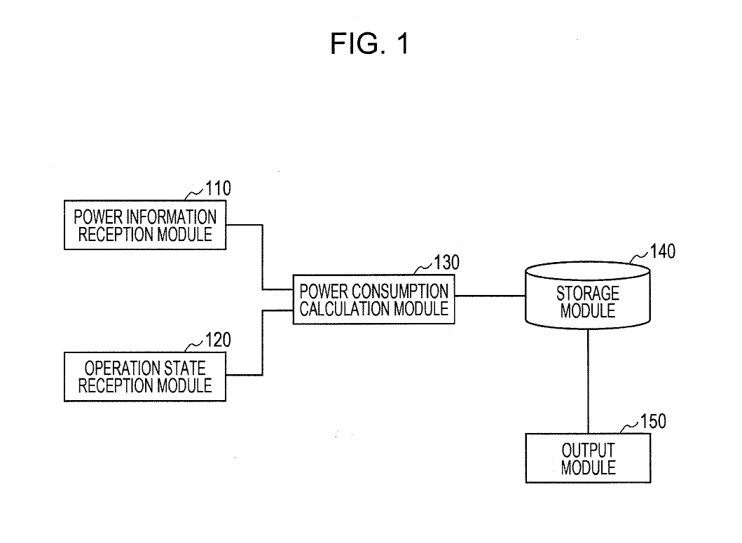

FIG. 1 is a block diagram illustrating conceptual modules forming an information processing apparatus according to this exemplary embodiment.

Generally, modules are software (computer programs) components or hardware components that can be logically separated from one another. Accordingly, the modules of this exemplary embodiment of the invention are not only modules of a computer program, but also modules of a hardware configuration. Accordingly, the exemplary embodiment will also be described in the form of a computer program for allowing a computer to function as those modules (a program for causing a computer to execute program steps, a program for allowing a computer to function as corresponding units, a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program is stored in a storage device. Modules may correspond to functions based on a one-on-one relationship. In terms of implementation, however, one module may be constituted of one program, or plural modules may be constituted of one program. Conversely, one module may be constituted of plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationship among data elements, etc.). The term “predetermined” means being determined prior to a certain operation, and includes the meaning of being determined prior to a certain operation before starting processing of the exemplary embodiments, and also includes the meaning of being determined prior to a certain operation even after starting processing of the exemplary embodiments, in accordance with the current situation/state or in accordance with the previous situation/state. A description having the meaning “in the case of A, B is performed” is used as the meaning “it is determined whether case A is satisfied, and B is performed if it is determined that case A is satisfied”, unless such a determination is necessary.

A system or an apparatus may be realized by connecting plural computers, hardware units, devices, etc., to one another via a communication medium, such as a network (including communication based on a one-on-one correspondence), or may be realized by a single computer, hardware unit, device, etc. The terms “apparatus” and “system” are used synonymously. The term “system” does not include merely a man-made social “mechanism” (social system).

Additionally, before performing an operation by using a corresponding module or when performing plural operations by using a corresponding module, target information is read from a storage device, and after performing the operation, a processed result is written into the storage device. Accordingly, a description of reading from the storage device before an operation or writing into the storage device after an operation may be omitted. Examples of the storage device may include a hard disk, a random access memory (RAM), an external storage medium, a storage device using a communication circuit, a register in a central processing unit (CPU), etc.

An information processing apparatus of this exemplary embodiment serves to calculate power consumption of a device being operated in operation states. The information processing apparatus includes, as shown in FIG. 1, a power information reception module 110, an operation state reception module 120, a power consumption calculation module 130, a storage module 140, and an output module 150.

The power information reception module 110 is connected to the power consumption calculation module 130. The power information reception module 110 receives information concerning power consumption of a target device (hereinafter such information will also be referred to as “power information”) and time information.

The target device may have at least plural operation states, and the power information reception module 110 calculates power consumption of the target device for the plural operation states. For example, the target device may be an image processing apparatus used in an office, and more specifically, a copying machine, a fax machine, a scanner, a printer, or a multifunction device (image processing apparatus including two or more functions of a scanner, a printer, a copying machine, a fax machine, etc.). The target device may be a personal computer or an air-conditioning system.

Information concerning power consumption may be any information as long as it is information from which power consumption of a target device can be calculated, and more specifically, power consumption per unit time, amperes, or volts, etc. Information concerning power consumption may indicate power actually consumed by the target device and represented by a measured value. For example, the power information reception module 110 receives time information and information concerning power consumption of the target device from a measuring unit (power measuring unit 220, which will be discussed later), which measures the power consumption of devices in operation.

Concerning the time information, if a measuring unit measures the power consumption of a target device at predetermined regular time intervals (e.g., every one minute) and outputs measured values to the information processing apparatus of this exemplary embodiment, the time information received by the power information reception module 110 is time information concerning the time during the time interval. If the measuring unit outputs time information when there is any change in information concerning power consumption output from the measuring unit, the time information is time information concerning the time when information concerning the power consumption is changed. The time information may include any of the time units, such as year, month, day, hour, minute, second, and smaller than seconds, or any combination thereof. The time information received by the operation state reception module 120 is also indicated in a similar manner.

The operation state reception module 120 is connected to the power consumption calculation module 130. The operation state reception module 120 receives information concerning an operation state of a device and time information.

Operation states are generally called operation modes, and each indicates a state in which the device is being used. In the case of the above-described image processing apparatus by way of example, the operation states are a power saving mode, a power reducing mode, a warm-up state, a standby state, a print state, a scan state, a fax state, etc.

The operation state reception module 120 receives, from a target device, information concerning an operation state of the target device and time information.

Information concerning an operation state of a device that is received by the operation state reception module 120 may be information that allows a user to uniquely identify the operation state of the device in this exemplary embodiment.

Concerning the time information, if a device outputs information concerning an operation state of the device at predetermined regular time intervals (e.g., every one minute) to the information processing apparatus of this exemplary embodiment, the time information received by the operation state reception module 120 is time information concerning the time corresponding to the time interval. If the device outputs information when there is any change in the operation state of the device, the time information is time information concerning the time at which the operation state of the device is changed.

It is necessary that the time set in the measuring unit that measures power consumption coincide with the time set in a target device. That is, the time of the measuring unit and the time of the target device are adjusted in advance.

The power consumption calculation module 130 is connected to the power information reception module 110, the operation state reception module 120, and storage module 140. The power consumption calculation module 130 calculates, on the basis of time information received by the power information reception module 110 and time information received by the operation state reception module 120, power consumption of a target device being operated in a certain operation state. The power consumption calculation module 130 calculates power consumed during a period from a start time of a target operation state to an end time thereof. For example, the power consumption calculation module 130 extracts, from time information received by the power information reception module 110, time information concerning the start time of a certain operation state of a device received by the operation state reception module 120. The power consumption calculation module 130 also extracts time information concerning the end time of the certain operation state from the time information received by the power information reception module 110. Then, the power consumption calculation module 130 calculates power consumed in the device in the certain operation state by using information concerning power consumed in the device from the start time to the end time of the certain operation state. If the information concerning power consumption received by the power information reception module 110 indicates power consumption per unit time, the power consumption calculation module 130 multiplies the value of power consumption per unit time by a time period from the start time to the end time of the certain operation.

If power consumed in the past in a certain operation state of the device is stored in the storage module 140, the power consumption calculation module 130 may adjust the calculated power value. For example, the calculated power value may be adjusted to a statistical value (e.g., average, median, mode, etc.) determined by using the power value in the past and the currently calculated power value. Alternatively, the calculated power value may be adjusted by using the difference between the power value in the past and the currently calculated power value. For example, a predetermined proportion (e.g., 40%) of the difference between the past power value and the currently calculated power value may be added to the lower value of the two power values. In this case, if 50% of the difference is added to the lower power value, the result is the same as that when the two power values are averaged. Additionally, the power values may be weighted. For example, a weight may be applied in accordance with a time elapsed from the current time. More specifically, a higher weight may be applied to power consumed more recently, and a lower weight may be applied to the power consumed less recently.

The storage module 140 is connected to the power consumption calculation module 130 and the output module 150. The storage module 140 stores therein values of power consumption of a device being operated in operation states which have been calculated by the power consumption calculation module 130. For example, the storage module 140 stores therein a power consumption value in association with device identification information for uniquely identifying a device in this exemplary embodiment and information indicating an operation state of the device.

The output module 150 is connected to the storage module 140. The output module 150 outputs information concerning power consumption values stored in the storage module 140 or calculated by the power consumption calculation module 130. Examples of outputting of information concerning power consumption values are printing of the information by using a printer, displaying of the information on a display device, transmitting of an image indicating a power consumption value by using an image transmitting apparatus, such as a fax machine, writing of the information into a database, storing of the information in a storage medium, such as a memory card, and supplying of the information to another information processing apparatus.

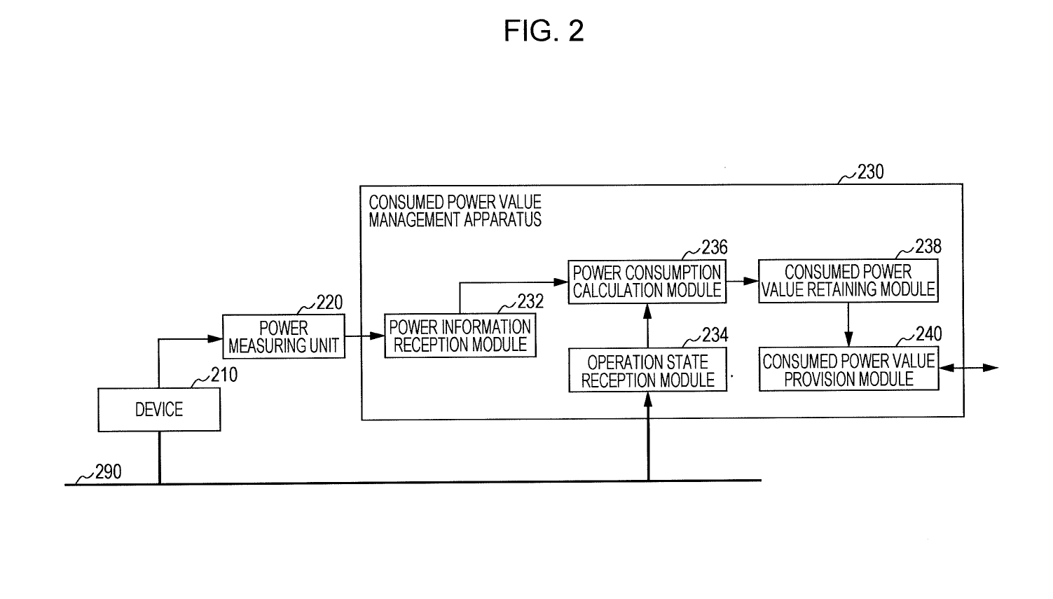

FIG. 2 is a block diagram illustrating modules forming a configuration of a system of this exemplary embodiment. The system shown in FIG. 2 includes a device 210, a power measuring unit 220, and a consumed power value management apparatus 230.

The device 210 is connected to the power measuring unit 220, and is also connected to an operation state reception module 234 of the consumed power value management apparatus 230 via a communication line 290. The device 210 is a device whose power consumption is measured and corresponds to the above-described image processing apparatus.

The power measuring unit 220 is connected to the device 210 and a power information reception module 232 of the consumed power value management apparatus 230. The power measuring unit 220 serves to measure power consumption of the device 210, and supplies results of measuring power to the consumed power value management apparatus 230 as information concerning power consumed in the device 210. As the power measuring unit 220, a known measuring unit may be used. For example, the power measuring unit 220 measures voltage (V), current (A), power (W), apparent power (VA), power supply frequency (Hz), power factor (PF), integrated power (kWH), accumulated time (H), etc., and supplies measuring results to the consumed power value management apparatus 230 via an interface, such as a universal serial bus (USB), together with time information.

The consumed power value management apparatus 230 includes the power information reception module 232, the operation state reception module 234, a power consumption calculation module 236, a consumed power value retaining module 238, and a consumed power value provision module 240.

The power information reception module 232 is connected to the power measuring unit 220 and the power consumption calculation module 236, and corresponds to the power information reception module 110 shown in FIG. 1. The power information reception module 232 may store therein information concerning power consumption and time information received from the power measuring unit 220.

The operation state reception module 234 is connected to the power consumption calculation module 236 and is also connected to the device 210 via the communication line 290. The operation state reception module 234 corresponds to the operation state reception module 120 shown in FIG. 1. The operation state reception module 234 receives information concerning an operation state of the device 210 from a management information base (MIB) by performing simple network management protocol (SNMP) communication. The operation state reception module 234 may store therein information indicating an operation state and time information received from the device 210. If, for example, an operator performs an operation to change the operation state of the device 210, the device 210 sends information concerning a change in the operation state to the operation state reception module 234.

The power consumption calculation module 236 is connected to the power information reception module 232, the operation state reception module 234, and the consumed power value retaining module 238. The power consumption calculation module 236 corresponds to the power consumption calculation module 130 shown in FIG. 1.

The consumed power value retaining module 238 is connected to the power consumption calculation module 236 and the consumed power value provision module 240. The consumed power value retaining module 238 corresponds to the storage module 140 shown in FIG. 1.

The consumed power value provision module 240 is connected to the consumed power value retaining module 238 and corresponds to the output module 150 shown in FIG. 1.

A communication line connecting the power measuring unit 220 and the consumed power value management apparatus 230 and the communication line 290 may be wired or wireless lines, such as the Internet.

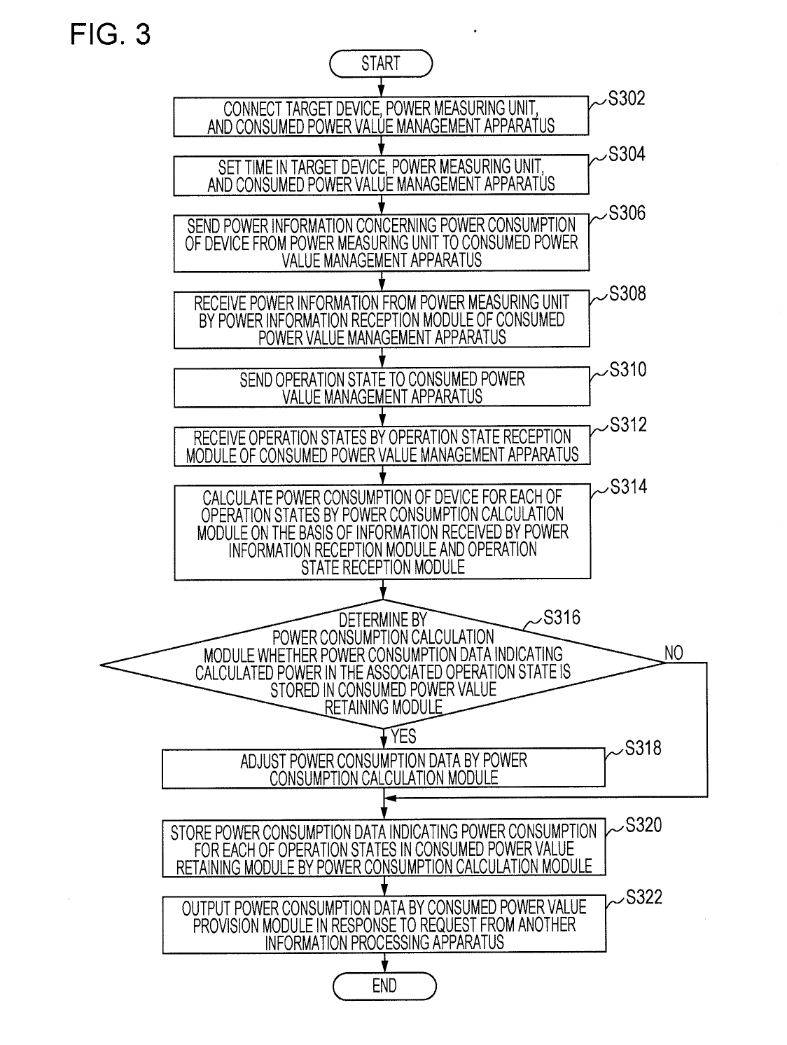

FIG. 3 is a flowchart illustrating an example of processing performed in this exemplary embodiment. Steps S302 and S304 are preprocessing, and it is sufficient if steps S302 and S304 are executed once before starting step S306. If steps S302 and S304 have already been executed, processing of the flowchart in FIG. 3 may be started from step S306.

In step S302, the device 210, the power measuring unit 220, and the consumed power value management apparatus 230 are connected to one another. Those components are connected to one another in order to allow the power measuring unit 220 to measure power consumed in the device 210 and to allow the consumed power value management apparatus 230 to receive information concerning an operation state of the device 210 from the device 210 and to receive power information indicating power consumption in the device 210 measured by the power measuring unit 220 from the power measuring unit 220.

In step S304, the time is set in the device 210, the power measuring unit 220, and the consumed power value management apparatus 230. As stated above, the time of the measuring unit 220 and the time of the target device 210 may be adjusted in advance.

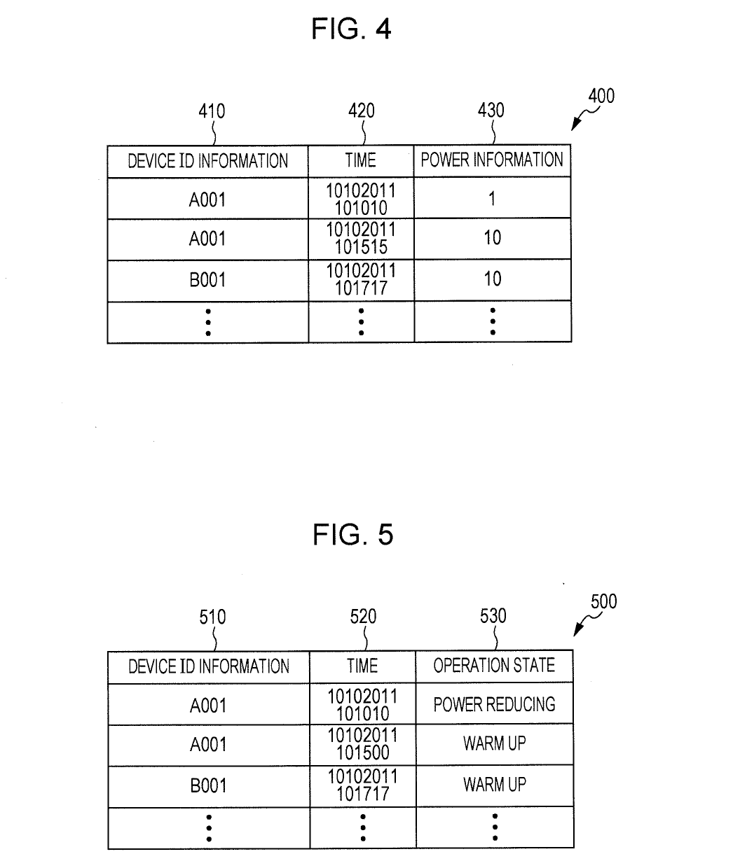

In step S306, the power measuring unit 220 sends power information concerning power consumption of the device 210 to the consumed power value management apparatus 230. The power measuring unit 220 sends, for example, a power information table 400 shown in FIG. 4. FIG. 4 illustrates an example of the data structure of the power information table 400. The power information table 440 includes a device identification (ID) information column 410, a time column 420, and a power information column 430. In the device ID information column 410, information for uniquely identifying the device 210 in this exemplary embodiment is stored. If the device 210 is the only one device, the device ID information column 410 may not be provided. In the time column 420, time information is stored. In this example, time information indicates the time when power information is changed. In the power information column 430, power information is stored. In this example, a power value indicated in the power information column 430 in a certain row remains the same until the time indicated in the next row is reached.

In step S308, the power information reception module 232 of the consumed power value management apparatus 230 receives power information concerning power consumption of the device 210, for example, the power information table 400, from the power measuring unit 220.

In step S310, the device 210 sends an operation state of the device 210 to the consumed power value management apparatus 230. The device 210 sends, for example, an operation state table 500 shown in FIG. 5. FIG. 5 illustrates an example of the data structure of the operation state table 500. The operation state table 500 includes a device ID information column 510, a time column 520, and an operation state column 530. In the device ID information column 510, information for uniquely identifying the device 210 in this exemplary embodiment is stored. If the device 210 is the only one device, the device ID information column 510 may not be provided. In the time column 520, time information is stored. In this case, the time (start time) when the operation state is changed is stored. In the operation state column 530, operation states are stored. In this example, an operation state indicated in the operation state column 530 in a certain row remains the same until the time elapses to that indicated in the next row. Accordingly, the time indicated in the next row in the operation state table 500 is the start time of the next operation state.

In step S312, the operation state reception module 234 of the consumed power value management apparatus 230 receives information concerning operation states of the device 210, for example, the operation state table 500, from the device 210.

In step S314, the power consumption calculation module 236 calculates power consumption of the device 210 for each of the operation states, on the basis of power information received by the power information reception module 232 and operation state information received by the operation state reception module 234. More specifically, the power consumption calculation module 236 extracts, from the operation state table 500, a start time and an end time of a certain operation state of the device 210 for which power consumption is calculated, and then extracts power information corresponding to the extracted start time and end time from the power information table 400. The power consumption calculation module 236 then calculates power consumption of the device 210 by using the extracted power information.

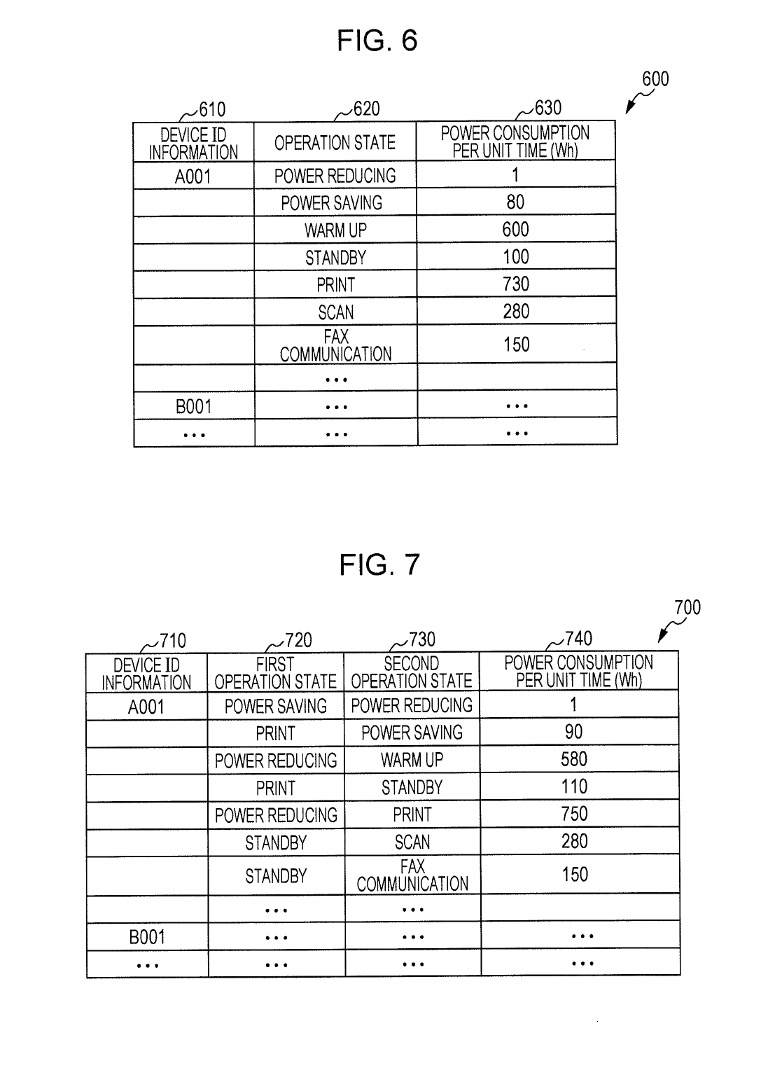

In step S316, the power consumption calculation module 236 determines whether power consumption data indicating calculated power value is stored in the consumed power value retaining module 238. If the result of step S316 is YES, the process proceeds to step S318. If the result of step S316 is NO, the process proceeds to step S320. That is, the power consumption calculation module 236 determines whether power consumption of the device 210 in the associated operation state has been calculated. The consumed power value retaining module 238 stores therein, for example, a device-operation-state/power-consumption table 600. FIG. 6 illustrates an example of the data structure of the device-operation-state/power-consumption table 600. The device-operation-state/power-consumption table 600 includes a device ID information column 610, an operation state column 620, and a power consumption (per unit time) column 630. In the device ID information column 610, information for uniquely identifying the device 210 in this exemplary embodiment is stored. In the operation state column 620, operation states are stored. In the power consumption (per unit time) column 630, power consumed in a certain device in a certain operation state is stored. Those items of information are stored in the associated columns row by row in step S320. In step S316, the power consumption calculation module 236 determines whether power consumption data indicating power consumption calculated in step S314 in the certain operation state of the device 210 has already been stored in the device-operation-state/power-consumption table 600.

In step S318, the power consumption calculation module 236 adjusts the power value indicated in the power consumption data and calculated in step S314 by using power consumption data stored in the consumed power value retaining module 238. As stated above, the calculated power value may be adjusted to, for example, the average of the power value stored in the consumed power value retaining module 238 and the power value calculated in step S314.

In step S320, the power consumption calculation module 236 stores power consumption data concerning power consumption of the device 210 for each of the operation states in the consumed power value retaining module 238. In the above-described example, power consumption data is stored row by row in the device-operation-state/power-consumption table 600. If power consumption data in a certain operation state of the device 210 has already been stored in the device-operation-state/power-consumption table 600, it may be overwritten by a new item of data, or a new row may be added to store the power value calculated in step S318. If a new row is added, a new column in which time information is stored may be added to the device-operation-state/power-consumption table 600.

In step S322, in response to a request from another information processing apparatus, the consumed power value provision module 240 outputs power consumption data indicating power consumption of the device 210 for each of the operation states.

In step S314, power consumption of the device 210 is calculated for each of the operation states of the device 210. Alternatively, power consumption of the device 210 may be calculated for a combination of two operation states. That is, one operation state of the device 210 may be a combination of operation state B at a certain time and operation state A, which is continuously shifted from the operation state B. In other words, an operation state of the device 210 may be the operation state B shifted from the operation state A. This is because power consumption necessary for shifting to the operation state B is influenced by the operation state A, which is immediately before the operation state B.

In this case, steps S314 through S322 are executed by replacing each of the operation states with a combination of the operation state A and the operation state B.

For example, the device-operation-state/power-consumption table 600 stored in the consumed power value retaining module 238 is replaced by a device-operation-state/power-consumption table 700 shown in FIG. 7. FIG. 7 illustrates an example of the data structure of the device-operation-state/power-consumption table 700. The device-operation-state/power-consumption table 700 includes a device ID information column 710, a first-operation state column 720, a second-operation state column 730, and a power consumption (per unit time) column 740. In the device ID information column 710, information for uniquely identifying the device 210 in this exemplary embodiment is stored. In the first-operation state column 720, the operation state A is stored. In the second-operation state column 730, the operation state B is stored. In the power consumption (per unit time) column 740, power consumption in a certain operation state of a certain device (operation state B shifted from the operation state A) is stored. The first-operation state column 720 and the second-operation state column 730 correspond to the operation state column 620 of the device-operation-state/power-consumption table 600.

In order to extract the operation state A, the operation state table 500 sent from the device 210 may be used. Alternatively, information indicating the operation states and time information stored in the operation state reception module 234 may be used. That is, the operation state A immediately before the operation state B may be extracted from the operation states stored in the operation state reception module 234.

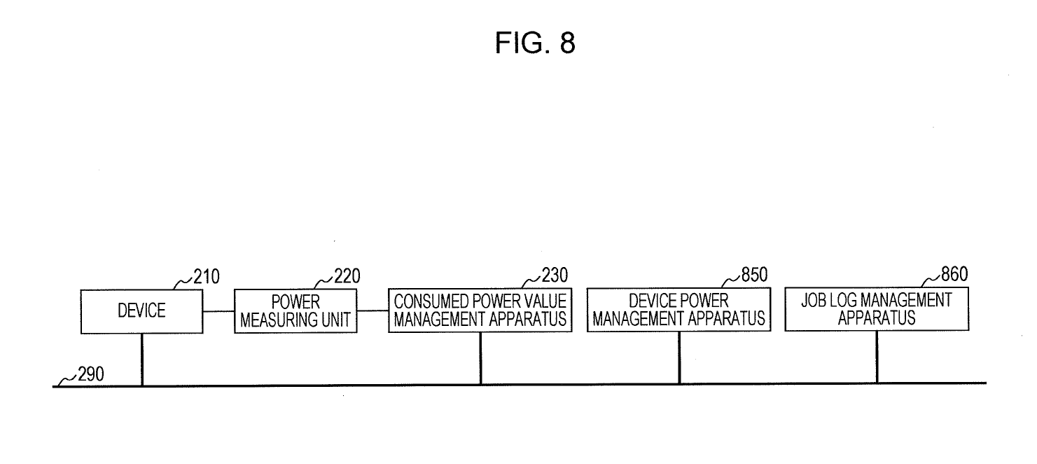

FIG. 8 illustrates an example of the configuration of a system of this exemplary embodiment. The device 210, the consumed power value management apparatus 230, a device power management apparatus 850, and a job log management apparatus 860 are connected to one another via the communication line 290. This configuration is equal to a configuration in which the device management apparatus 850 and the job log management apparatus 860 are added to the configuration shown in FIG. 2.

The device power management apparatus 850 performs power control of the device 210. For example, the device power management apparatus 850 may calculate the time period before the device 210 is shifted to the power saving state, and may set the calculated time period in the device 210.

The consumed power value provision module 240 of the consumed power value management apparatus 230 outputs information concerning power consumption of the device 210 in operation states to the device power management apparatus 850 via the communication line 290. In this case, the information output to the device power management apparatus 850 may indicate power consumption of the device 210 for each of the operation states or power consumption of the device 210 in all the operation states.

The job log management apparatus 860 manages a running status (job log) of the device 210. For example, the job log management apparatus 860 obtains a running status of the device 210 from the MIB by performing SNMP communication and stores the obtained running status therein. The obtained running status is information equivalent to information received by the operation state reception module 234 of the consumed power value management apparatus 230.

The device power management apparatus 850 receives power consumption data indicating power consumption of the device 210 for each of the operation states from the consumed power value provision module 240. The device power management apparatus 850 then calculates the time period before the device 210 is shifted to the power saving state, on the basis of the received power consumption data indicating power consumption of the device 210 for each of the operation states, and sets the calculated time period in the device 210.

The term “power saving state” is generally called a power reducing mode, a power saving mode, an energy saving mode, or a sleep mode, and indicates the state in which the device 210 is in the standby mode with low power. However, the time taken for the device 210 to return from the power saving state to the running state is longer than that to return from the standby state, which is different from the power saving state, to the running state.

Shifting to the power saving state means that the device 210 is shifted from the standby state (which is different from the power saving state and in which the device 210 can return to the running state in a very short time) to the power saving state for the purpose of power saving or energy saving. A function of shifting to the power saving state is called an “automatic power off” function. The device 210 is provided with this function.

The time to shift to the power saving state means the period from which the device 210 is in an operation state other than the power saving state until which the device 210 is shifted to the power saving state. A shorter time of this period is more effective for power saving or energy saving, but on the other hand, the efficiency is reduced since the time period before the device 210 is returned to the running state becomes longer.

The device power management apparatus 850 performs power control as follows. For example, if the upper limit of power consumption is set for each department in an office, the device power management apparatus 850 sets the time period before the device 210 is shifted to the power saving state in order to efficiently control power consumption of the device 210. More specifically, in a time zone in which efficiency is prioritized (time zone in which the device 210 is frequently used, e.g., a time zone in which a predetermined number of employees or more are in the office or a time zone just before a meeting starts), a longer time is set for the standby state, which is different from the power saving state. In contrast, in a time zone in which the device 210 is less frequently used, e.g., during a lunch break, a longer time is set for the power saving state. That is, in a time zone in which efficiency is prioritized, the time period before the device 210 is shifted to the power saving state is set to be longer, and in a time zone in which the device 210 is less frequently used, the time period before the device 210 is shifted to the power saving state is set to be shorter. The term “longer” or “shorter” time period before which the device 210 is shifted to the power saving state is based on a comparison between the time period before the device 210 is shifted to the power saving state in one time zone and that in the other time zone. Alternatively, a predetermined time may be set as the time period before the device 210 is shifted to the power saving state.

The time zone in which efficiency is prioritized and the time zone in which the device 210 is less frequently used are determined by the device power management apparatus 850 on the basis of information received from the job log management apparatus 860. The device power management apparatus 850 calculates, as the running state, the number of times the device 210 is used per unit time (e.g., if the device 210 is a copying machine, the number of times the copying function is used or the number of pages printed using the copying function per hour from 9:00 to 17:00). If the calculated number of times is equal to or greater than a predetermined number, the device power management apparatus 850 sets such a time zone to be the “time zone in which efficiency is prioritized”. If the calculated number of times is smaller than the predetermined number, the device power management apparatus 850 sets such a time zone to be the “time zone in which the device 210 is less frequently used”. The device power management apparatus 850 then sets the time period before which the device 210 is shifted to the power saving state in association with identification information for uniquely identifying the device 210.

Alternatively, the device power management apparatus 850 may obtain, from an information processing apparatus that manages the presence and the absence of employees in the office, a status reflecting the number of employees at the desk near the device 210, and may set a time zone in which a predetermined number of employees or more are in the office as the “time zone in which efficiency is prioritized”.

Alternatively, the device power management apparatus 850 may obtain, from an information processing apparatus that manages the reservation status of meeting rooms, the reservation status of a meeting room near the device 210, and may set a time zone in which a meeting is about to be held in the meeting room as the “time zone in which efficiency is prioritized”.

The device power management apparatus 850 and the job log management apparatus 860 may also employ the technology disclosed in Japanese Unexamined Patent Application Publication No. 2007-065255 when performing processing, such as calculating the time period before the device 210 is shifted to the power saving state.

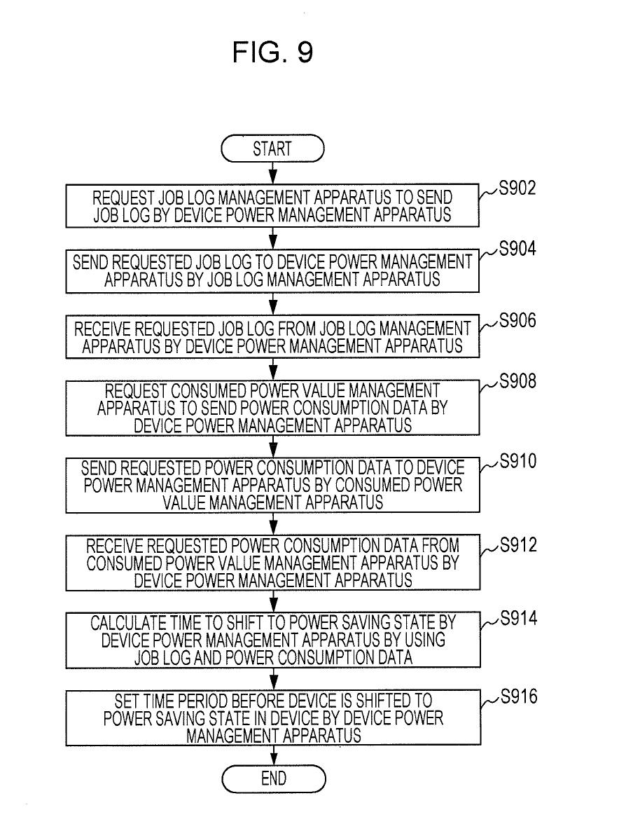

FIG. 9 is a flowchart illustrating an example of processing performed in this exemplary embodiment.

In step S902, the device power management apparatus 850 requests the job log management apparatus 860 to send a job log.

In step S904, the job log management apparatus 860 sends a requested job log to the device power management apparatus 850.

In step S906, the device power management apparatus 850 receives the requested job log from the job log management apparatus 860.

In step S908, the device power management apparatus 850 requests the consumed power value management apparatus 230 to send power consumption data.

In step S910, the consumed power value management apparatus 230 sends the requested power consumption data to the device power management apparatus 850.

In step S912, the device power management apparatus 850 receives the requested power consumption data from the consumed power value management apparatus 230.

In step S914, the device power management apparatus 850 calculates the time period before the device 210 is shifted to the power saving state by using the job log and the power consumption data.

In step S916, the device power management apparatus 850 sets the calculated time period before the device 210 is shifted to the power saving state in the device 210.

A description will now be given of processing performed by the consumed power value management apparatus 230 when the device power management apparatus 850 requests the consumed power value management apparatus 230 to send power consumption data concerning a device for which power consumption of the device is not measured.

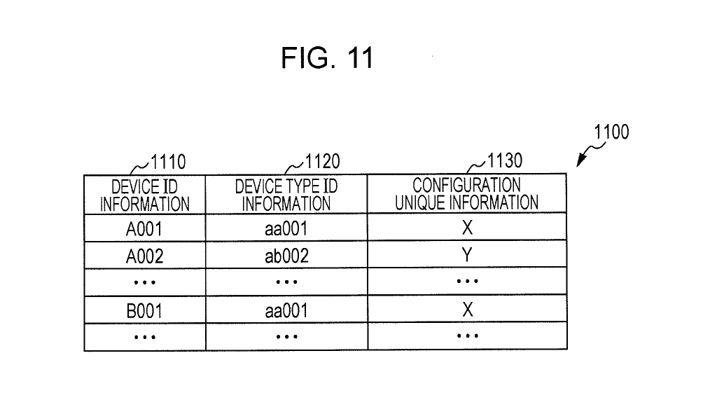

If power consumption of a target device in operation states is not calculated, the power consumption calculation module 236 extracts the device type of the target device from a device/device-type table 1100 shown in FIG. 11, and adjusts a reference power consumption value associated with the device type, thereby calculating power consumption of the device. The term “target device” means a device that receives a request to output power consumption data from the device power management apparatus 850. The reference power consumption value associated with the device type may be obtained, by using the device type as a key, from a table in which device types and reference power consumption values are stored in association with each other. An adjustment value for adjusting the reference power consumption value may be calculated by using configuration unique information of the associated device type.

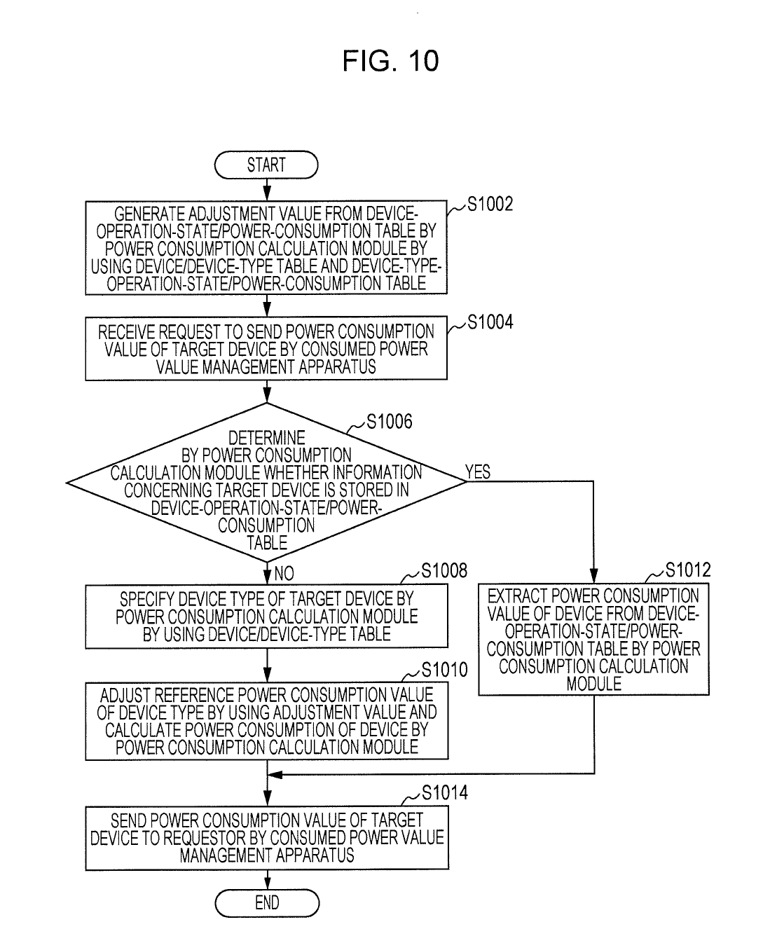

FIG. 10 is a flowchart illustrating an example of processing performed in this exemplary embodiment.

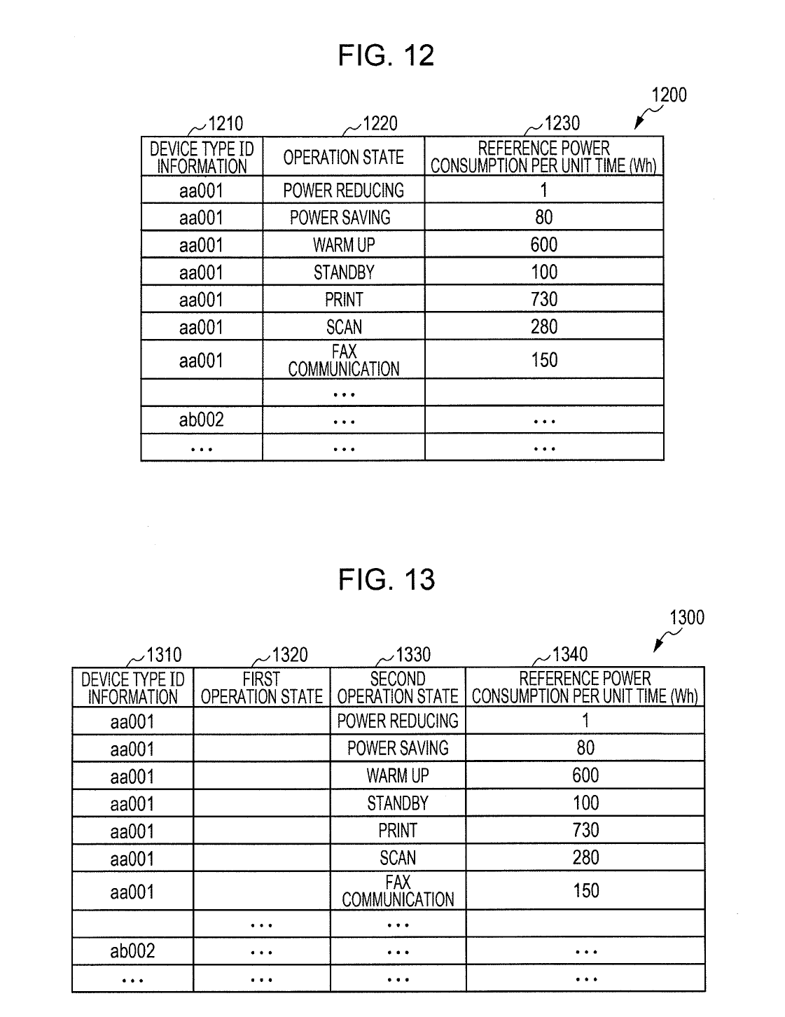

In step S1002, the power consumption calculation module 236 generates an adjustment value from the device-operation-state/power-consumption table 600 by using the device/device-type table 1100 and a device-type-operation-state/power-consumption table 1200 shown in FIG. 12.

FIG. 11 illustrates an example of the data structure of the device/device-type table 1100. The device/device-type table 1100 stores therein devices and device types in association with each other. The device/device-type table 1100 includes a device ID information column 1110, a device type ID information column 1120, and a configuration unique information column 1130. In the device ID information column 1110, information for uniquely identifying the device 210 in this exemplary embodiment is stored. In the device type ID information column 1120, information for uniquely identifying a device type in this exemplary embodiment is stored. The device type indicates the type of device. Accordingly, one or more devices are associated with one device type. In the configuration unique information column 1130, information concerning the body of a device and components other than the body (more specifically, if a device is a multifunction device, components other than the body are additional functions, such as an automatic document feeder and a post-processing unit (finisher, etc.) performing punching, document binding (stapling), paper folding, etc.), is stored.

FIG. 12 illustrates an example of the data structure of the device-type-operation-state/power-consumption table 1200. The device-type-operation-state/power-consumption table 1200 includes a device type ID information column 1210, an operation state column 1220, and a reference power consumption (per unit time) column 1230. In the device type ID information column 1210, information for uniquely identifying a device type in this exemplary embodiment is stored. In the operation state column 1220, operation states are stored. In the reference power consumption (per unit time) column 1230, the reference power consumption value in a certain type of device in a certain operation state is stored. The reference power consumption value may be a power value consumed in a certain type of device (predetermined standard device, e.g., a device without additional functions) and calculated by the power consumption calculation module 236, or may be a predetermined value.

The adjustment value may be a coefficient used for performing addition, subtraction, multiplication, and division on the reference power consumption value in the reference power consumption (per unit time) column 1230 of the device-type-operation-state/power-consumption table 1200. The adjustment value is generated for each device type. If there is a difference between the reference power consumption value and a measured power value (value in the power consumption column (per unit time) 630 of the device-operation-state/power-consumption table 600), the difference may be used as the adjustment value. Alternatively, a predetermined value may be added, subtracted, multiplied, or divided to, from, or by the difference. For example, 0.9 may be multiplied by the difference to generate the adjustment value.

The adjustment value may be stored for each of the operation states. For example, an adjustment value column may be added to the device/device-type table 1100, and the adjustment value may be stored in the adjustment value column.

The adjustment value may be generated on the basis of configuration unique information. More specifically, a device having configuration unique information (indicated in configuration unique information column 1130 of the device/device-type table 1100) similar to standard configuration unique information concerning the standard configuration of a device type is selected, and an adjustment value is generated by using the power consumption value associated with the selected device (indicated in the power consumption (per unit time) column 630 of the device-operation-state/power-consumption table 600).

The standard configuration unique information is set for each device type in advance. For example, the standard configuration unique information may be set as “only body” as a default, or may be stored in a table in association with the device type.

Referring back to a description of the flowchart of FIG. 10, in step S1004, the consumed power value management apparatus 230 receives a request to send a power consumption value of a target device.

In step S1006, the power consumption calculation module 236 determines whether information concerning the target device is stored in the device-operation-state/power-consumption table 600. If the result of step S1006 is YES, the process proceeds to step S1012, and if the result of step S1006 is NO, the process proceeds to step S1008.

In step S1008, the power consumption calculation module 236 specifies a device type of the target device by using the device/device-type table 1100. More specifically, the power consumption calculation module 236 searches for the device from the device ID information column 1110 of the device/device-type table 1100, and extracts the device type associated with the searched device from the device type ID information 1120.

In step S1010, the power consumption calculation module 236 adjusts the reference power consumption value of the device type by using an adjustment value, thereby calculating power consumption of the device associated with the device type. More specifically, the power consumption calculation module 236 searches for the device type from the device type ID information column 1210 of the device-type-operation-state/power-consumption table 1200, and extracts the reference power consumption value associated with the searched device type from the reference power consumption (per unit time) column 1230. The power consumption calculation module 236 then adjusts the reference power consumption value by adding, subtracting, multiplying, or dividing an adjustment value to, from, or by the reference power consumption value.

In step S1012, the power consumption calculation module 236 extracts the power consumption value of the device from the device-operation-state/power-consumption table 600. That is, since the power consumption value of the device requested by the device power management apparatus 850 is stored in the device-operation-state/power-consumption table 600, the power consumption calculation module 236 extracts the associated power consumption value from the device-operation-state/power-consumption table 600.

In step S1014, the consumed power value management apparatus 230 sends the power consumption data of the target device to the requestor (device power management apparatus 850).

In the flowchart of FIG. 10, in step S1004, the consumed power value management apparatus 230 receives a request to send power consumption value of a target device from the device power management apparatus 850. Alternatively, the device power management apparatus 850 may request the consumed power value management apparatus 230 to send power consumption of a device for each of the operation states. In this case, the reference power consumption value (indicated in the reference power consumption (per unit time) column 1230 of the device-type-operation-state/power-consumption table 1200) of the device type of a device for each of the operation states is adjusted by using an adjustment value for the associated operation state.

As stated above, each operation state may be a combination of a certain operation state in a certain time and an operation state, which has been shifted immediately from the certain operation state. In this case, instead of the device-type-operation-state/power-consumption table 1200, a device-type-operation-state/power-consumption table 1300 may be used. FIG. 13 illustrates an example of the data structure of the device-type-operation-state/power-consumption table 1300. The device-type-operation-state/power-consumption table 1300 includes a device type ID information column 1310, a first-operation state column 1320, a second-operation state column 1330, and a reference power consumption (per unit time) column 1340. In the device type ID information column 1310, information for uniquely identifying a device type in this exemplary embodiment is stored. In the first-operation state column 1320, the operation state A is stored. In the second-operation state column 1330, the operation state B is stored. In the reference power consumption (per unit time) column 1340, the reference power consumption in a certain operation state of a certain device (operation state B shifted from the operation state A) is stored. The first-operation state column 1320 and the second-operation state column 1330 correspond to the operation state column 1220 of the device-type-operation-state/power-consumption table 1200.

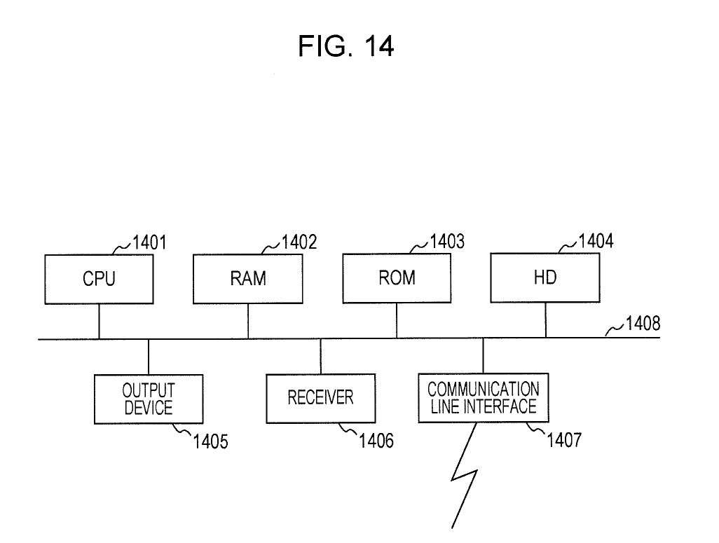

An example of the hardware configuration of a computer that executes the program of this exemplary embodiment is that of a general-purpose computer, as shown in FIG. 14, i.e., a computer which serves as a personal computer or a server. More specifically, such a computer includes a CPU 1401 as a processor (arithmetic unit), and a RAM 1402, a read only memory (ROM) 1403, and a hard disk (HD) 1404 as storage devices. The CPU 1401 executes a program, such as the power consumption calculation module 130. The RAM 1402 stores therein such a program and data. The ROM 1403 stores therein a program for starting the computer. The HD 1404 serves as an auxiliary storage device. The computer also includes an output device 1405, a receiver 1406, and a communication line interface 1407. The output device 1405 may be a cathode ray tube (CRT) or a liquid crystal display device. The receiver 1406 receives data in response to an operation performed by a user on a keyboard, a mouse, a touch panel, etc. The communication line interface 1407 may be a network interface card used for connecting the computer with a communication network. The above-described components are connected to one another to send and receive data via a bus 1408. Two or more of such computers may be connected to one another via a network.

In the above-described exemplary embodiment, functions in the form of a software computer program are implemented by reading the software computer program into a system having the hardware configuration and by performing operations in cooperation of software and hardware resources.

The hardware configuration shown in FIG. 14 is an example only, and this exemplary embodiment may be configured in any manner as long as the modules described in the exemplary embodiment are executable. For example, some modules may be configured as dedicated hardware (e.g., an application specific integrated circuit (ASIC)), or some modules may be installed in an external system and be connected to the personal computer via a communication line. Alternatively, plural systems, such as those shown in FIG. 14, may be connected via a communication line, and may be operated in cooperation with each other. The modules may be integrated into a device other than a computer, such as a home information appliance, a copying machine, a fax machine, a scanner, a printer, or a multifunction device.

The above-described program may be stored in a recording medium and be provided. The program recorded on a recording medium may be provided via a communication medium. In this case, the above-described program may be implemented as a “computer readable medium storing the program therein” in an exemplary embodiment of the invention.

The “computer readable medium storing a program therein” is a recording medium storing a program therein that can be read by a computer, and is used for installing, executing, and distributing the program.

Examples of the recording medium include digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered), a magneto-optical disk (MO), a flexible disk (FD), magnetic tape, a hard disk, a ROM, an electrically erasable programmable read only memory (EEPROM) (registered), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination such networks. The program may be transmitted by using carrier waves.

The above-described program may be part of another program, or may be recorded, together with another program, on a recording medium. The program may be divided and recorded on plural recording media. Further, the program may be recorded in any form, e.g., it may be compressed or encrypted, as long as it can be reconstructed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first reception unit that receives information concerning power consumption of a target device and time information;
a second reception unit that receives information concerning an operation state of the target device and time information;
a calculator that calculates a value of power consumption of the target device in the operation state, on the basis of the time information received by the first reception unit and the time information received by the second reception unit; and
an output unit that outputs the value of power consumption of the target device calculated by the calculator.

2. An information processing system comprising:
an information processing apparatus; and
a power controller that performs power control of a target device,
the information processing apparatus including
a first reception unit that receives information concerning power consumption of the target device and time information,
a second reception unit that receives information concerning an operation state of the target device and time information,
a calculator that calculates a value of power consumption of the target device in the operation state, on the basis of the time information received by the first reception unit and the time information received by the second reception unit, and
an output unit that outputs the value of power consumption of the target device calculated by the calculator,
wherein the output unit of the information processing apparatus outputs the value of power consumption of the target device to the power controller,
the power controller including
a third reception unit that receives the value of power consumption of the target device output from the output unit,
a transition time calculator that calculates a time period that is to elapse before the target device is shifted to a power saving state on the basis of the value of power consumption of the target device received by the third reception unit, and
a setting unit that sets, in the target device, the time period that is to elapse before the target device is shifted to the power saving state calculated by the transition time calculator.

3. The information processing apparatus according to claim 1, further comprising:
a device/device-type storage unit that stores a device and a device type of the device in association with each other,
wherein, if the calculator has not calculated power consumption of a target device in an operation state, the calculator extracts a device type associated with the target device from the device/device-type storage unit and adjusts a reference power consumption value of the extracted device type, thereby calculating power consumption of the target device.

4. The information processing system according to claim 2, further comprising:
a device/device-type storage unit that stores a device and a device type of the device in association with each other,
wherein, if the calculator of the information processing apparatus has not calculated power consumption of a target device in an operation state, the calculator extracts a device type associated with the target device from the device/device-type storage unit and adjusts a reference power consumption value of the extracted device type, thereby calculating power consumption of the target device.

5. The information processing apparatus according to claim 1, wherein the operation state of the target device is a combination of a first operation state at a certain time and a second operation state immediately before the first operation state.

6. The information processing apparatus according to claim 3, wherein the operation state of the target device is a combination of a first operation state at a certain time and a second operation state immediately before the first operation state.

7. The information processing system according to claim 2, wherein the operation state of the target device is a combination of a first operation state at a certain time and a second operation state immediately before the first operation state.

8. The information processing system according to claim 4, wherein the operation state of the target device is a combination of a first operation state at a certain time and a second operation state immediately before the first operation state.

9. An information processing method comprising:
receiving information concerning power consumption of a target device and time information;
receiving information concerning an operation state of the target device and time information;
calculating a value of power consumption of the target device in the operation state, on the basis of the received time information associated with the power consumption and the time information associated with the operation state; and
outputting the calculated value of power consumption of the target device.

10. A computer readable medium storing a program causing a computer to execute a process, the process comprising:
receiving information concerning power consumption of a target device and time information;
receiving information concerning an operation state of the target device and time information;
calculating a value of power consumption of the target device in the operation state, on the basis of the received time information associated with the power consumption and the time information associated with the operation state; and
outputting the calculated value of power consumption of the target device.
